(19) United States
(12) Patent Application Publication
(10) Pub. No.: US 2018/0296961 A1
(43) Pub. Date: Oct. 18, 2018

(54) ARTICLES FOR CARBON DIOXIDE CAPTURE AND METHODS OF MAKING THE SAME

(71) Applicant: Corning Incorporated, Corning, NY (US)

(72) Inventors: Dayue David Jiang, Painted Post, NY (US); Steven Bolaji Ogunwumi, Painted Post, NY (US)

(73) Assignee: Corning Incorporated, Corning, NY (US)

(21) Appl. No.: 15/767,856

(22) PCT Filed: Oct. 13, 2016
(86) PCT No.: PCT/US2016/056721

§ 371 Date: Apr. 12, 2018

Related U.S. Application Data
(60) Provisional application No. 62/242,539, filed on Oct. 16, 2015.

(51) Int. Cl. B01D 46/24; B01D 53/14

(52) U.S. Cl. CPC B01D 46/247; B01D 46/2474; B01D 53/1425; B01D 53/1475; B01D 2046/2433; B01D 2257/504; B01D 2252/204; B01D 2253/108; B01D 2253/204; B01D 2253/308; B01D 2046/2437

(57) ABSTRACT

An article for capturing carbon dioxide and methods of making the same. The article includes a honeycomb substrate and an amine alcohol. The amine alcohol is contained within the porous partition walls of the honeycomb substrate. The article may be used in processes for removing an acid gas from a target gas.

This application claims the benefit of priority under 35 U.S.C. § 119 of U.S. Provisional Application Ser. No. 62/242,539 filed on Oct. 16, 2015, the content of which is relied upon and incorporated herein by reference in its entirety.

### BACKGROUND

The present disclosure relates generally to sorbent articles for capturing carbon dioxide (CO₂) from a target gas and methods of making the same.

### SUMMARY

According to one embodiment of the present disclosure, a carbon dioxide capture article is disclosed. The article comprises a substrate and an amine alcohol capable of absorbing carbon dioxide from a target gas. The substrate can be formed from, for example, a cordierite, a hydrophilic zeolite, metal organic frameworks (MOF), and like materials, or combinations thereof. The substrate includes a plurality of partition walls with a plurality of pores. An amine alcohol is contained within at least one of the plurality of pores of the substrate. The amine alcohol can be, for example monoethanolamine, diethanolamine, triethanolamine, 1-(2-Hydroxyethyl)piperazine, N-(3-Aminopropyl)diethanolamine, and similar alcohols, or combinations thereof. The amine alcohol is contained within at least one of the plurality of pores of the substrate.

According to yet another embodiment of the present disclosure, a method of manufacturing a carbon dioxide capture article is disclosed. The method comprises contacting a substrate and a first volume of an amine alcohol. The substrate may be formed, for example, from a cordierite, a hydrophilic zeolite, a metal organic framework, and like materials, or combinations thereof. The substrate includes a plurality of partition walls with a plurality of pores. A portion of the first volume of the amine alcohol is contained within at least one of the plurality of pores of the substrate.

### BRIEF DESCRIPTION OF THE DRAWINGS

The disclosure will be better understood, and features, aspects and advantages other than those set forth above will become apparent when consideration is given to the following detailed description thereof. Such detailed description makes reference to the following drawings, wherein:

FIG. 1 is an end view of a cordierite article loaded with an amine alcohol according to an exemplary embodiment.

FIG. 2 is a perspective view of the cordierite article illustrated in FIG. 1.

FIG. 3 is an end view of a zeolite article loaded with an amine alcohol according to according to an exemplary embodiment.

FIG. 4 is a perspective view of the zeolite article illustrated in FIG. 3.

FIG. 5 is a perspective view of another zeolite article loaded with an amine alcohol according to an exemplary embodiment.

FIG. 6 is a perspective view of the zeolite article illustrated in FIG. 5.

FIG. 7 is a plot of a carbon dioxide absorption curve for the cordierite article loaded with an amine alcohol shown in FIGS. 1-2.

FIG. 8 is a plot of a carbon dioxide desorption curve for the cordierite article loaded with an amine alcohol shown in FIGS. 1-2.

FIG. 9 is a plot of a carbon dioxide absorption curve for the zeolite article loaded with an amine alcohol shown in FIGS. 3-4.

FIG. 10 is a plot of a carbon dioxide absorption curve for the zeolite article loaded with an amine alcohol shown in FIGS. 5-6.

FIG. 11 is a plot of a carbon dioxide desorption curve for the zeolite article loaded with an amine alcohol shown in FIGS. 3-4.

FIG. 12 is a plot of a carbon dioxide desorption curve for the zeolite article loaded with an amine alcohol shown in FIGS. 5-6.

### DETAILED DESCRIPTION

Unless defined otherwise, all technical and scientific terms used herein have the same meaning as commonly understood by one of ordinary skill in the art to which the disclosure belongs. Although any methods and materials similar to or equivalent to those described herein can be used in the practice or testing of the present disclosure, the preferred methods and materials are described below.

Conventional methods of absorbing acidic gases, including carbon dioxide (CO₂) and sulfur dioxide (SO2), have included counter-current liquid-gas packed-bed methods and scrubber methods. In these processes, the acid gas is physically absorbed into the liquid sorbent via fast capture kinetics. Liquid scrubbing processes may be advantageous because the liquid sorbent has a large surface area for contacting the acid gas. Shortcomings of these methods however, include the high cost and large quality of liquid sorbent required. Also, liquid sorbents are often fouled by contact with system components.

Another conventional method of absorbing acid gases has included membrane separation technologies (e.g., inorganic based and organic polymer based membranes). A shortcoming of this method includes an inverse proportionality between selective separation of acid gas and pressure drop across the system. Membrane separation of acid gases also has very high costs for large scale applicability.

Yet another conventional method of absorbing acid gases has included solid sorbent processes where the acid gas is adsorbed onto the solid sorbent surface. In some processes, the solid sorbent is on a support structure. Solid sorbent processes may be advantageous because they include both pressure swing adsorption (PSA) and thermal swing adsorption (TSA). Solid sorbents have included poly amines (e.g., polyethyleneimine) among other multi amine polymers. Shortcomings of solid sorbent processes include generating sufficient surface area for adsorption of the desired quantity of acid gas.

The present disclosure provides an alternative to conventional methods for capturing CO₂. The sorbent article 100 of the present disclosure is an carbon dioxide capture article for capturing CO₂. In one embodiment, article 100 is capable of selectively capturing carbon dioxide from a target gas. The target gas may be atmospheric gasses or gases from coal-fired power plants, liquid or gas petrochemical fired power plants, or other similar processes where the concentration of CO₂ is greater than, for example, 300 parts per million.

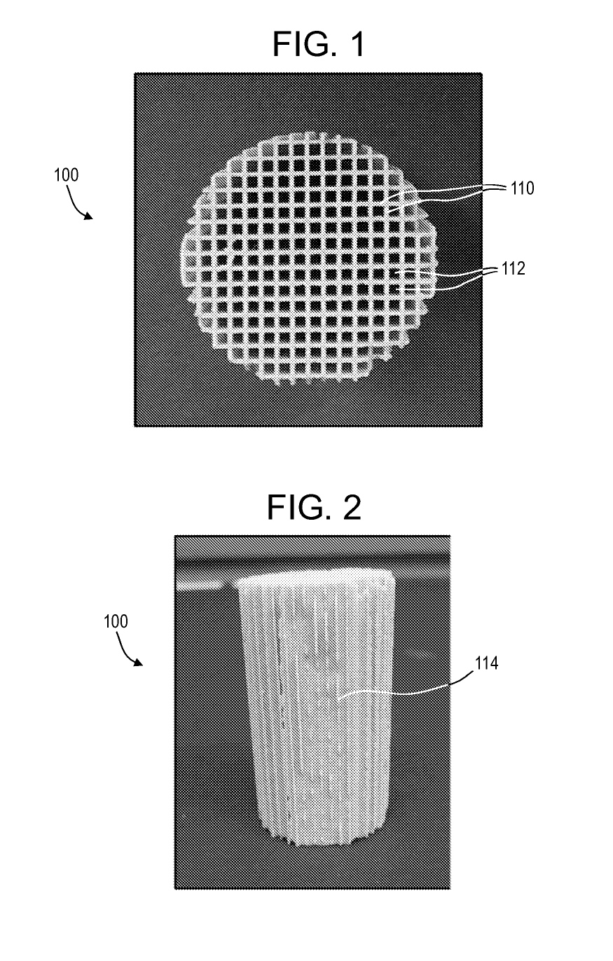

Article 100 of the present disclosure includes a substrate and an amine alcohol. In one embodiment, the substrate is a honeycomb substrate, a permeable body, or any other porous body capable of acting as a substrate for an amine alcohol of the present disclosure. As shown in FIGS. 1, 3, and 5, honeycomb substrate includes a plurality of partition walls 110 extending in an axial direction from an inlet end to an outlet end. The plurality of partition walls 110 may be porous including a plurality of individual or interconnected pores. The plurality of partition walls may also form a plurality of flow channels 112 through which the target gas stream may flow. Partition walls 110 may have a thickness TD of at least 0.05 millimeters (mm) up to 2.5 mm. Partition walls 110 may have a median thickness TD of 0.05 mm≤TD≤0.26 mm. A skin 114 may define the outer diameter of article 100.

Article 100 may include a flow-through honeycomb including open channels 112 defined by partition walls 110. In one embodiment, the honeycomb substrate comprises a porous substrate capable of retaining an acid gas sorbent. The honeycomb substrate may also have from about 31 to 140 flow channels 112 (also called open cells) per square centimeter of the honeycomb substrate. In one embodiment, open cells 112 are substantially parallel with the axial direction. Open cells 112 are defined by partition walls 110. Open cell density may be from about 200 to about 900 cells per square inch (CPSI), or even from about 300 to about 800 CPSI. Open cells may have a diameter of at least 0.1 mm or greater (e.g., from about 0.5 mm to about 2.5 mm) to limit pressure drop of the target gas across article 100. A subset of the plurality of open cells in the substrate may be masked (or plugged) to create a filter (like a diesel particulate filter) to force flow of the target gas perpendicular the axial direction through partition walls 110.

In exemplary embodiments, honeycomb substrate has porosity greater than about 5%. Honeycomb substrate may also have from about 10% to about 90% porosity, or from about 30% to about 80% porosity. The plurality of pores within partition walls 110 may have a diameter between about 0.1 microns and about 20 microns, or about 0.1 microns to about 10 microns, or even from about 0.2 microns to about 5 microns. In exemplary embodiments, the pores have a diameter greater than 6 angstroms. The plurality of pores within partition walls 110 may also have a median pore diameter D50 from about 0.2 microns to about 5 microns. The pore diameters with the partition walls 110 are configured to contain the amine alcohol. The pores may also be configured such that water does not compete with the amine alcohol for containment therein.

Honeycomb substrate of the present disclosure may be formed from cordierites, zeolites, metal organic frameworks (MOFs), and inorganic oxides. In one embodiment, the honeycomb substrate is formed from cordierite, a hydrophilic zeolite, or combinations thereof. Hydrophilic zeolites can be, for example, 13X, ZSM-5, EMT, NaY, an aluminophosphate, chabazite, halloysite, MCM-41, and combinations thereof. Other conventional hydrophilic zeolites are according to the present disclosure. For example, a hydrophilic zeolite may have a silicon to aluminum ratio (n_{Si}:n_{Al}) of 1≤n_{Si}:n_{Al}≤50. Honeycomb substrate of the present disclosure may also be formed from hydrophobic MOFs. MOFs of the present disclosure are assembled from metal clusters and organic linkers to accomplish a hydrophobic, porous composition. An example MOF includes zeolithic imidazole frameworks (e.g., ZIF-8) which can also made hydrophobic by post modification with a fluoroalkyl or alkyl substituents.

The honeycomb substrate of the present disclosure may be formed from precursor materials including binders (e.g., clay, methylcellulose, etc.) or organic material (e.g., fatty acids, etc.) with the inorganic materials (i.e., cordierites, zeolites, MOFs, inorganic oxides, or combinations thereof) and extruding the precursor materials into a green body. Pore formers may also be included within the precursor materials, including but not limited to graphite, cellulose materials, and other commonly known pore formers. The green body may be fired at temperatures between about 1000° C. and 2000° C. to form the substrate. The substrate may also be fired at lower temperatures (e.g., 800° C.) to reduced firing costs while still forming pores and adequate strength in the fired substrate to be used in an absorbing process.

Article 100 of the present disclosure also includes an amine alcohol. The amine alcohol may be contained within at least one of the plurality of pores of the honeycombs substrate. In another embodiment, the amine alcohol is contained within at least 20%, or at least 50%, or even up to 90% or more of the plurality of pores of the honeycombs substrate. The amount of amine alcohol contained within the plurality of pores of the honeycomb substrate (i.e., loading) may be from about 0.1 grams to about 10 grams per cubic centimeter (of the honeycomb substrate), or from about 0.1 grams to about 5 grams per cubic centimeter, or even from about 0.1 grams to about 2 grams per cubic centimeter.

The amine alcohol of the present disclosure may be capable of absorbing acid gases, including but not limited to CO₂ and SO₂. In alternative embodiments, the amine alcohol is capable of selectively absorbing CO₂ from a target gas. Amine alcohols of the present disclosure may include, but are not limited to, monoethanolamine, diethanolamine, triethanolamine, 1-(2-Hydroxyethyl)piperazine, N-(3-Aminopropyl)diethanolamine, and combinations thereof. Other amine alcohols of the present disclosure may have a boiling point greater than 150° C. at standard temperature and pressure (STP). Amine alcohols of the present disclosure may also have a viscosity greater than the viscosity of water at a temperature between 20° C. and 400° C. Still further, the amine alcohol of the present disclosure may have been used in conventional counter-current liquid-gas packed-bed methods and scrubber methods.

A volume V2 of the amine alcohol of the present disclosure is contained within at least one of the plurality of pores of the substrate. Volume V2 is a portion of the amine alcohol volume V1 that contacts the substrate when forming article 100. In one embodiment, the amine alcohol is a liquid within the at least one of the plurality of pores of the substrate. In another embodiment, the liquid amine alcohol is contained within the at least one of the plurality of pores of the honeycomb substrate by a hydrophilic interaction. Alternatively, the liquid amine may be contained within the at least one of the plurality of pores of the honeycomb substrate by electrostatic interaction, hydrogen bonding, dipole interactions, or aromatic electronic interaction with cationic metal(s) within the substrate.

With the amine alcohol contained within the pores of the substrate, the present disclosure may provide advantages to conventional acid gas capture methods. Specifically, it may require less liquid sorbent than scrubber processes (as it is contained within the pores of the substrate) while retaining the high sorption surface area of the liquid. Additionally, the heat of desorption may be reduced as the substrate may be directly heated. Further, following several absorption/desorption cycles, degraded amine alcohol may be removed by flowing an amine alcohol solvent through article 100 to strip the degraded amine alcohol therefrom. Subsequently, the substrate may be regenerated with amine alcohols by processes of the present disclosure.

Article 100 may be used in conventional systems for capturing carbon dioxide. Specifically, article 100 may be used in systems and processes for capturing an acid gas from a target gas where the process is essentially or totally free of an acid gas sorbent except the volume of the amine alcohol contained within the substrate. Alternatively, article 100 may be used in parallel with other conventional methods and articles for capturing an acid gas from a target gas within a system. Article 100 may also be used in a process for capturing carbon dioxide comprising causing relative movement between article 100 and the target gas to absorb carbon dioxide from the target gas within the honeycomb substrate.

The present disclosure also includes methods of manufacturing article 100. The methods include contacting the substrate and a volume V1 of the amine alcohol. Contacting the substrate and the amine alcohol may be performed by immersing or soaking the substrate in the amine alcohol. Alternatively, amine alcohol may be rinsed, washed, or flowed over the substrate. In exemplary methods, the substrate may be impregnated (with or without vacuum) with the amine alcohol using conventional methods. Contacting the substrate and a volume V1 of the amine alcohol may cause volume V2 (a portion of the volume V1) to imbibe in the pores of the substrate.

By contacting the substrate and a volume V1 of the amine alcohol, a volume V2 of the amine alcohol is contained within the at least one of the plurality of pores of the contacted honeycomb substrate. In exemplary embodiments, volume V2 of the amine alcohol is a portion or fraction of the volume V1. In another method, contacting the substrate and volume V1 of the amine alcohol solution includes applying a vacuum to the substrate to draw volume V2 of the amine alcohol into the at least one of the plurality of pores of the substrate.

After contacting the substrate and the amine alcohol, methods of the present disclosure may also include separating the substrate and volume V1 of the amine alcohol (less volume V2). Separating may include removing the substrate from an amine alcohol bath or ceasing to introduce the amine alcohol to the substrate.

After contacting the substrate and the amine alcohol, methods of the present disclosure may also include washing the contacted substrate with a polar solvent (e.g., water, amine alcohol, etc.). Washing may include introducing the substrate to the polar solvent or introducing the polar solvent to the substrate. Washing the contacted substrate with the polar solvent may remove a fraction of volume V2 of the amine alcohol from the substrate. Alternatively, a fraction of volume V2 of the amine alcohol may be removed from the substrate by blowing with a pressurized gas (e.g., air). Yet alternatively, in an embodiment where the polar solvent is an amine alcohol, washing may increase volume V2 of the amine alcohol in the substrate.

### EXAMPLES

The present disclosure will be further clarified with reference to the following examples. The following examples are illustrative and should not be construed as limiting.

### Example 1—Cordierite Honeycomb Substrate (“CHS”)

A CHS was prepared using the batch composition as provided in Table 1 below. The materials in the batch composition of the CHS shown in Table 1 are provided in super addition notation to clearly indicate the weight percent of the inorganic components remaining in the resultant cordierite honeycomb substrate after firing.

TABLE 1
Batch Composition of the CHS

| Component | | Weight Percent |
|---|---|---|
| Category | Material | (wt. %) |
| Inorganic components | Barretts 93-37 Talc | 40.70 |
| | Kaolin, Hydrous | 14.33 |
| | Alumina - A3000 FL | 27.97 |
| | Fused Silica | 17.00 |
| Binders/Organic | Potato Starch | 10.00 |
| components | Methylcellulose - F240 | 4.00 |
| | Deionized water | 29.85 |
| | Tall Oil Fatty Acid L-5 | 0.60 |
| | Durasyn 162, Polyalphaolefin | 6.00 |

| | |
|---|---|
| Total | 150.45 |

The dry inorganic components in Table 1 were first mixed to form a solid mixture. The liquid addition, including the binders and organic components, were then added to the mixture of the dry batch components and mulled together for approximately 15-20 minutes to provide a plasticized ceramic batch composition.

The plasticized ceramic batch composition was extruded under conditions suitable to form a wet or green honeycomb body. The wet or green honeycomb body was then dried in a humidity controlled oven to less than 10% moisture. A gas furnace was then used to fire the green bodies at about 1400° C. for about 15 hours to form the cordierite honeycomb substrate. After firing, the inorganic components of the batch composition remain as part of the resultant cordierite honeycomb substrate. The CHS, however, is essentially free of the binders/organic component shown in Table 1 as they are degradated or removed during firing. The resultant CHS had a cell geometry of about 46.5 cells per square centimeter (about 300 cells per square inch) and a cell wall thickness of about 0.254 millimeters (0.10 inches). The resultant CHS also had a mass of about 28.5 grams and a total volume of about 52.5 cubic centimeters. The CHS was evaluated and determined to have a total porosity of about 49%. The pores within the cells walls of the CHS had a median pore diameter D50 of about 20 microns and a surface area of about 22.5 square centimeters per cubic centimeter of the CHS.

A 65 wt. % diethanolamine (DEA) aqueous solution was prepared at about 20° C. The CHS was submerged in the 65 wt. % DEA aqueous solution for about 60 seconds. The CHS was then removed from the 65 wt. % DEA aqueous solution and set aside to dry at room temperature for 3 days. Subsequently, the CHS was further dried in an oven at 70° C. for 3 hours to remove any remaining water. The CHS, now loaded with liquid DEA within its pores, was weighed to determine the amount of DEA loading based on a mass difference calculation. The DEA loaded CHS was determined to have 5.7 grams of DEA loaded within the pores therein. The DEA loaded CHS is shown in FIGS. 1-2.

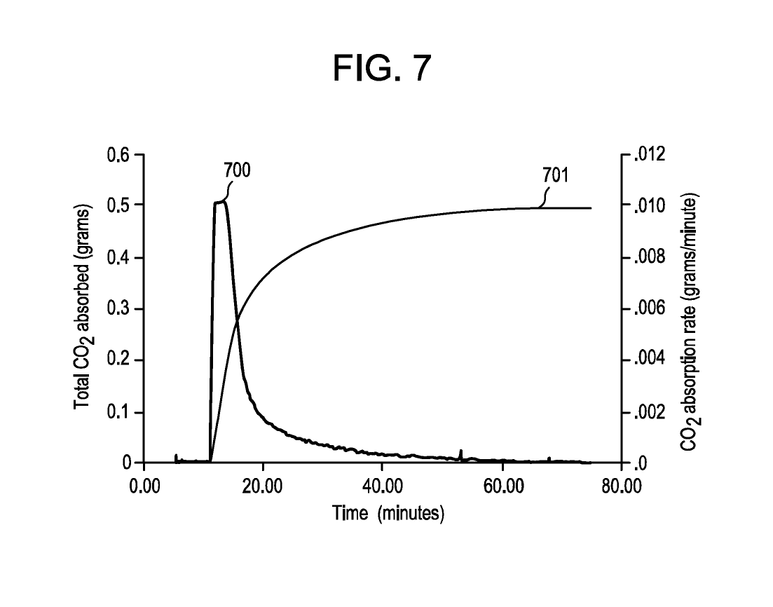

The DEA loaded CHS was then evaluated for carbon dioxide absorption capability. Specifically, the DEA loaded CHS was placed in a closed stainless steel tubular reactor. The DEA loaded CHS was degassed in the reactor for an hour at 85° C. by flowing pure nitrogen there through at 500 cubic centimeters per minute. Gas analysis at the reactor inlet and outlet was performed using a MultiGas™ MKS Fourier Transform Infrared Spectroscopy (FTIRS) with a 20/20™ 5.11 meter gas cell and a mercury-cadmium-telluride (MCT) detector with 0.5 cm⁻¹ to 1 cm⁻¹ resolution (the “Gas Analyzer”). The temperature inside the reactor was monitored by the Gas Analyzer at the reactor inlet and outlet at about 30° C. The Gas Analyzer also monitored the carbon dioxide concentration at the reactor inlet and outlet and provided the absorption curves in FIG. 7. After about 10 minutes the reactor cooled to 25-30° C. and a target gas with about 9-10 wt. % carbon dioxide, and the balance 90-91 wt. % nitrogen, was flowed through the reactor inlet at about 500 cubic centimeters per minute to the reactor outlet for about 70 minutes.

FIG. 7 provides two curves: (1) a CO₂ absorption rate curve 700 (measured on the right vertical axis, in grams per minute); and (2) a total CO₂ absorbed curve 701 (measured on the left vertical axis, in grams). The CO₂ absorption rate curve 700 represents the grams of carbon dioxide absorbed by the DEA loaded CHS as a function of time. The total CO₂ absorbed was determined by integrating and calculating the area under curve 700. A total of 0.51 grams of carbon dioxide was absorbed by the DEA loaded CHS. That is, the absorption of carbon dioxide was 2.03 millimoles of CO₂ per gram of DEA loaded on the CHS.

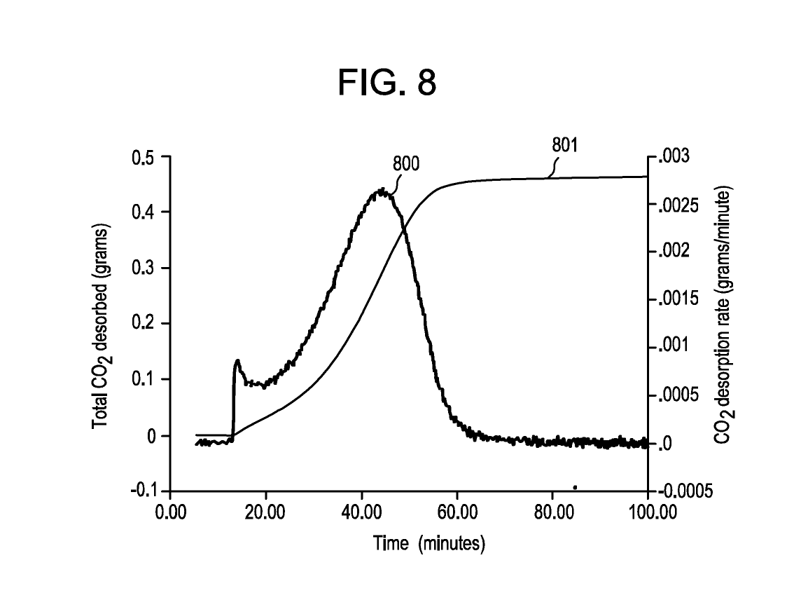

Subsequently, the DEA loaded CHS with 0.51 grams of CO₂ absorbed therein was evaluated for CO₂ desorption inside the reactor. Specifically, pure nitrogen gas was flowed through the reactor across the DEA loaded CHS at 500 cubic centimeters per minute for about 5 minutes to remove CO₂ in the feed gas. The pure nitrogen feed gas was then fed through a furnace to heat the reactor to about 110° C. in about 5 minutes. After 5 minutes the reactor reached 110° C. and desorption of CO₂ from the DEA loaded CHS as measured by the Gas Analyzer at the reactor outlet. Desorption curves are provided in FIG. 8.

FIG. 8 provides two curves: (1) a CO₂ desorption rate curve 800 (measured by the right vertical axis, in grams per minute); and (2) a total CO₂ desorbed curve 801 (measured by the left vertical axis, in grams). The CO₂ absorption rate curve 800 represents the grams of carbon dioxide absorbed by the DEA loaded CHS as a function of time. The total CO₂ absorbed was determined by integrating and calculating the area under curve 800. A total of 0.46 grams of carbon dioxide was desorbed from CHS.

### Example 2—Zeolite Honeycomb Substrate (“ZHS”) #1 and ZHS #2

ZHS #1 and ZHS #2 were separately prepared using the batch composition as provided in Table 2 below. The materials in the batch composition of the zeolite honeycomb substrates shown in Table 2 are provided in super addition notation to clearly indicate the weight percent of the inorganic components remaining in ZHS #1 and ZHS #2 after firing.

TABLE 2
Batch Composition of ZHS #1 and ZHS #2

| | | Weight Percent | Weight Percent |
|---|---|---|---|
| Component | | (wt. %) in | (wt. %) in |
| Category | Material | ZHS #1 | ZHS #2 |
| Inorganic | Zeolite 13X | 71.00 | 100.00 |
| components | Arctic Mist ® Talc | 14.50 | 0.00 |
| | Bentonite (325 | 14.50 | 0.00 |
| | mesh) | | |
| Binders/Organic | Hydroxypropyl | 12.00 | 12.00 |
| components | Methylcellulose - | | |
| | F240 | | |
| | Sodium Stearate | 1.00 | 1.00 |
| | Liga SG3 | | |
| | Durasyn 162, | 6.00 | 6.00 |
| | Polyalphaolefin | | |
| | Water | 30.00 | 30.00 |
| | Silres M 97E | 25.00 | 62.50 |
| | Emulsion (40% | | |
| | solution) | | |

| | | |
|---|---|---|
| Total | 174.00 | 211.50 |

The steps listed below where repeated separately for ZHS #1 and ZHS #2. The dry inorganic components in Table 2 were first mixed to form a solid mixture. The liquid addition, including the binders and organic components, were then added to the mixture of the dry batch components and mulled together for approximately 15-20 minutes to provide a plasticized zeolite batch composition.

The plasticized zeolite batch composition was extruded under conditions suitable to form a wet or green honeycomb body. The cell geometry of ZHS #1 was about 62 cells per square centimeter (about 400 cells per square inch) with a cell wall thickness of about 0.178 millimeters (0.007 inches). The cell geometry of ZHS #2 was about 139 cells per square centimeter (about 900 cells per square inch) and a cell wall thickness of about 0.076 millimeters (0.003 inches).

The wet or green honeycomb body for each substrate was then dried in a humidity controlled oven to less than 10% moisture. A gas furnace was then used to fire the green bodies at about 300-600° C. for about 3 hours to form ZHS #1 and ZHS #2. After firing, the inorganic components of the batch composition remain as part of the resultant zeolite honeycomb substrates. ZHS #1 and ZHS #2 are essentially free of the binders/organic component shown in Table 2 as they are degradated or removed during firing.

ZHS #1 had a mass of about 17.2 grams and a total volume of about 38.1 cubic centimeters. ZHS #1 was evaluated and determined to have a total porosity of about 50.36%. The pores within the cells walls of ZHS #1 ranged from 0.1 microns to 10 microns, had a median pore diameter D50 of about 0.3 microns, and a surface area of about 27.09 square centimeters per cubic centimeter of ZHS #1.

ZHS #2 had a mass of about 9.6 grams and a total volume of about 34.4 cubic centimeters. ZHS #2 was evaluated and determined to have a total porosity of about 45.86%. The pores within the cells walls of ZHS #2 ranged from 0.1 microns to 10 microns, had a median pore diameter D50 of about 0.6 microns, and a surface area of about 42.99 square centimeters per cubic centimeter of ZHS #2.

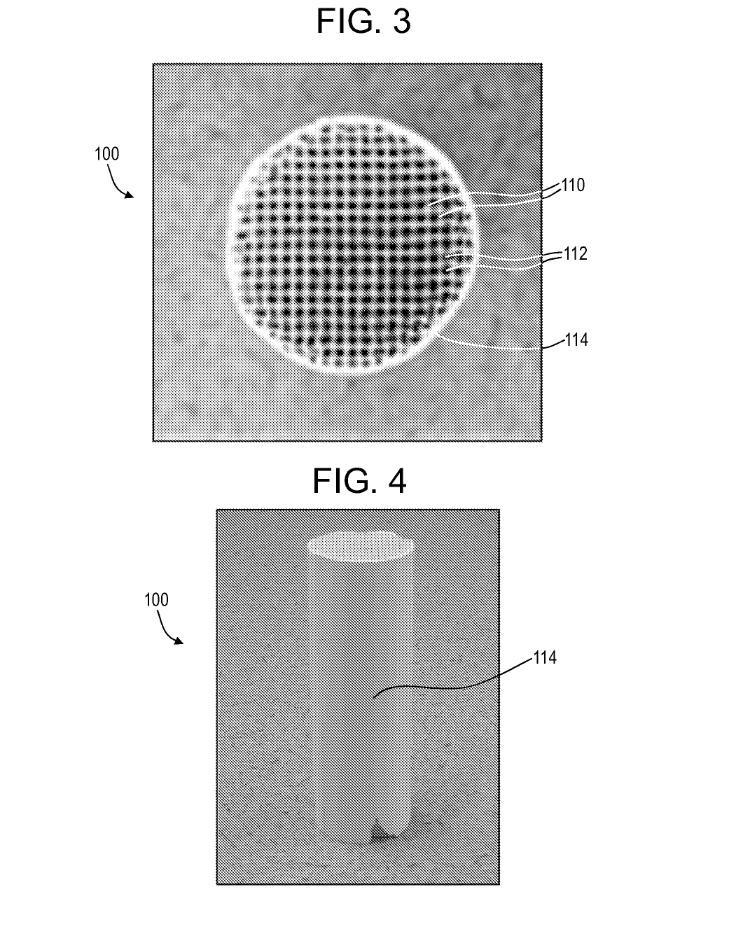

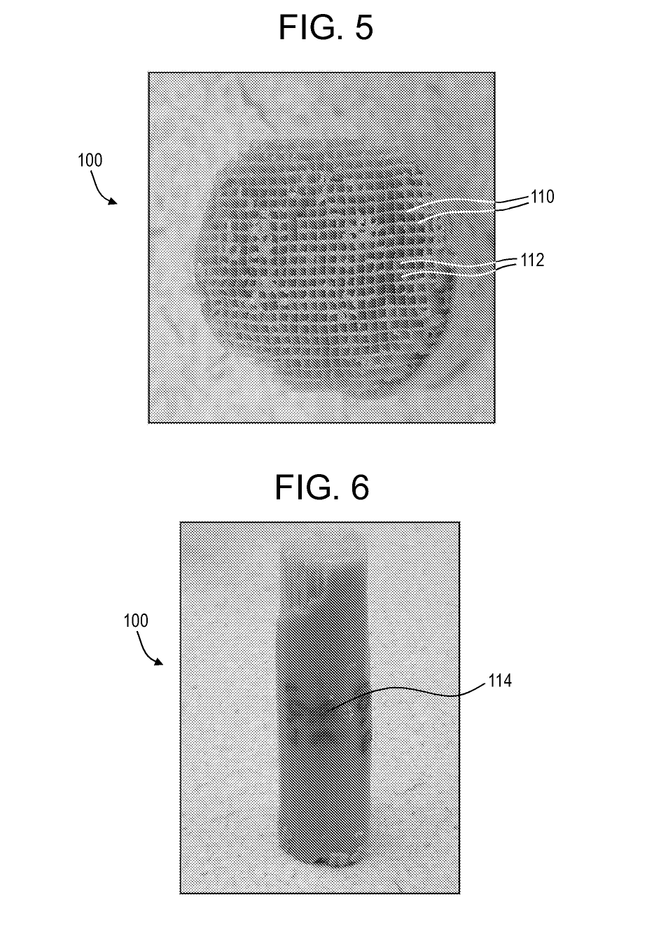

Two separate 65 wt. % diethanolamine (DEA) aqueous solution baths were prepared at about 20° C. Each of the zeolite honeycomb substrates were separately submerged in a 65 wt. % DEA aqueous solution for about 60 seconds. The zeolite honeycomb substrates were then removed from the 65 wt. % DEA aqueous solution and set aside to dry at room temperature for 3 days. Subsequently, the zeolite honeycomb substrates were further dried in an oven at 70° C. for 3 hours to remove any remaining water. The zeolite honeycomb substrates, now loaded with liquid DEA within their pores, were weighed to determine the amount of DEA loading based on a mass difference calculation. The DEA loaded ZHS #1 was determined to have 5.5 grams of DEA loaded within the pores therein. The DEA loaded ZHS #1 is shown in FIGS. 3-4. The DEA loaded ZHS #2 was determined to have 4.5 grams of DEA loaded within the pores therein. The DEA loaded ZHS #2 is shown in FIGS. 5-6.

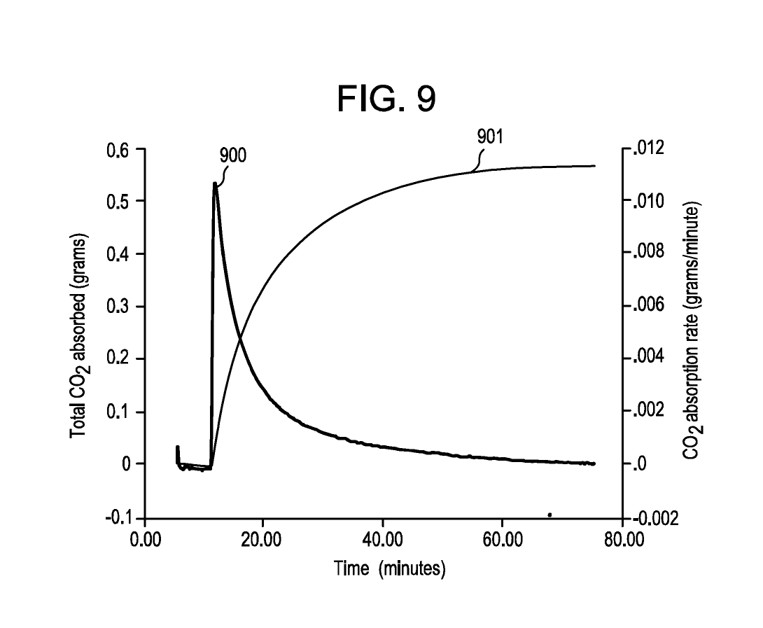

The DEA loaded zeolite honeycomb substrates were then evaluated for carbon dioxide absorption capability. In separate experiments, the DEA loaded zeolite honeycomb substrates were placed in a closed stainless steel tubular reactor. Each of the DEA loaded zeolite honeycomb substrates were degassed in the reactor for an hour at 85° C. by flowing pure nitrogen there through at 500 cubic centimeters per minute. Gas analysis at the reactor inlet and outlet was performed using the Gas Analyzer described in Example 1. The temperature inside the reactor was monitored by the Gas Analyzer at the reactor inlet and outlet at about 26° C. The Gas Analyzer also monitored the carbon dioxide concentration at the reactor inlet and outlet and provided absorption curves in FIGS. 9 & 10 for ZHS #1 & 2, respectively. After about 10 minutes for each ZHS, the reactor cooled to 25-30° C. and a target gas with about 9-10 wt. % carbon dioxide, and the balance 90-91 wt. % nitrogen, was flowed through the reactor inlet at about 500 cubic centimeters per minute to the reactor outlet for about 70 minutes.

FIG. 9 provides two curves: (1) a CO₂ absorption rate curve 900 (measured on the right vertical axis, in grams per minute); and (2) a total CO₂ absorbed curve 901 (measured on the left vertical axis, in grams). The CO₂ absorption rate curve 900 represents the grams of carbon dioxide absorbed by the DEA loaded ZHS #1 as a function of time. The total CO₂ absorbed was determined by integrating and calculating the area under curve 900. A total of 0.58 grams of carbon dioxide was absorbed by ZHS #1.

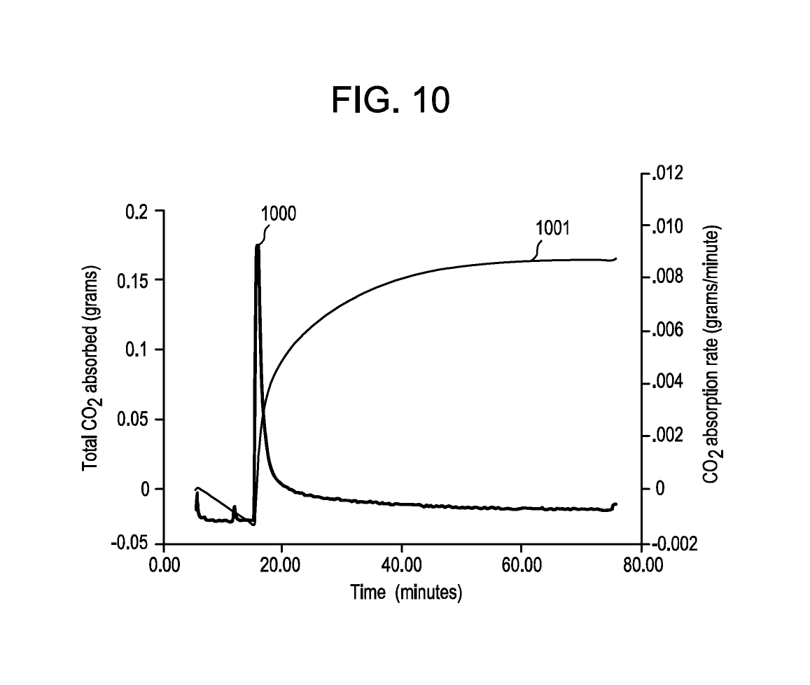

FIG. 10 provides two curves: (1) a CO₂ absorption rate curve 1000 (measured on the right vertical axis, in grams per minute); and (2) a total CO₂ absorbed curve 1001 (measured on the left vertical axis, in grams). The CO₂ absorption rate curve 1000 represents the grams of carbon dioxide absorbed by the DEA loaded ZHS #2 as a function of time. The total CO₂ absorbed was determined by integrating and calculating the area under curve 1000. A total of 0.19 grams of CO₂ was absorbed by ZHS #2.

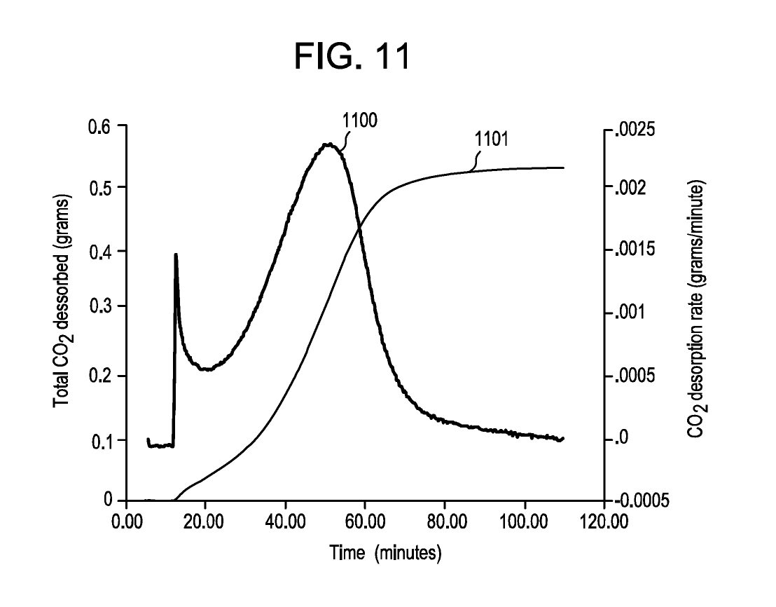

Subsequently, the DEA loaded ZHS #1 & 2 CO₂ absorbed therein was evaluated for CO₂ desorption inside the reactor. Separately, pure nitrogen gas was flowed through the reactor across the DEA loaded ZHSs at 500 cubic centimeters per minute for about 5 minutes to remove CO₂ in the feed gas. The pure nitrogen feed gas was then fed through a furnace to heat the reactor to about 110° C. in about 5 minutes. After 5 minutes the reactor reached 110° C. and desorption of CO₂ from the DEA loaded CHS as measured by the Gas Analyzer at the reactor outlet. Desorption curves are provided in FIGS. 11 & 12 for ZHS #1 & 2, respectively.

FIG. 11 provides two curves for ZHS #1: (1) a CO₂ desorption rate curve 1100 (measured by the right vertical axis, in grams per minute); and (2) a total CO₂ desorbed curve 1101 (measured by the left vertical axis, in grams). The CO₂ absorption rate curve 1100 represents the grams of carbon dioxide absorbed by the DEA loaded ZHS #1 as a function of time. The total CO₂ absorbed was determined by integrating and calculating the area under curve 1100. A total of 0.53 grams of carbon dioxide was desorbed from ZHS #1.

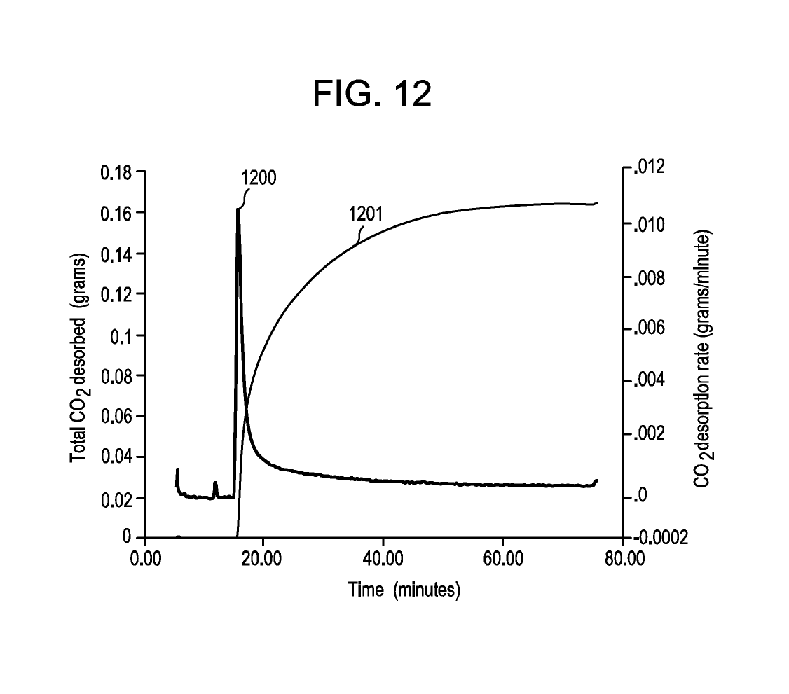

FIG. 12 provides two curves for ZHS #2: (1) a CO₂ desorption rate curve 1200 (measured by the right vertical axis, in grams per minute); and (2) a total CO₂ desorbed curve 1201 (measured by the left vertical axis, in grams). The CO₂ absorption rate curve 2100 represents the grams of carbon dioxide absorbed by the DEA loaded ZHS #2 as a function of time. The total CO₂ absorbed was determined by integrating and calculating the area under curve 1200. A total of 0.17 grams of carbon dioxide was desorbed from ZHS #2.

Table 3 below provides a comparative summary of amine alcohol loading, CO₂ absorption, and CO₂ desorption for the cordierite honeycomb substrate (in Example 1) and ZHS #1 and ZHS #2 (in Example 2).

TABLE 3
Comparative Summary of Amine Alcohol Loading, CO₂
Absorption, and CO₂ Desorption for Example 1 and 2 Substrates

| | Substrate | | | | | |
|---|---|---|---|---|---|---|
| | and DEA | Absorption | | | Desorption | |
| | | | | Grams | | Percent |
| | Substrate | | | CO₂ | | CO₂ |
| | mass (g)/ | Total | Millimoles | per 1000 | Total | desorbed |
| | DEA | CO₂ | CO₂ per | cm³ of | CO₂ | of CO₂ |
| Sample | loaded (g) | (g) | gram DEA | substrate | (g) | absorbed |
| CHS | 28.5/5.7 | 0.51 | 2.03 | 9.71 | 0.46 | 90 |
| (Example 1) | | | | | | |
| ZHS #1 | 17.2/5.5 | 0.58 | 2.36 | 15.2 | 0.53 | 91 |
| (Example 2) | | | | | | |
| ZHS #2 | 9.6/4.5 | 0.19 | 0.96 | 5.52 | 0.17 | 90 |
| (Example 2) | | | | | | |

Table 3 above shows that the CHS and both ZHSs showed desirable absorption and desorption cycling. ZHS #1 and #2 unexpectedly showed a high level of DEA loading. CHS and ZHS #1 unexpectedly showed high total CO₂ absorption capacity (i.e., ≥0.46 grams CO₂). Without being limited to any theory, the inventors suggest that the lower CO₂ absorption capacity in ZHS #2 was due to the smaller ZHS sample size and consequent DEA loading. Also, FIG. 5 provides that some of the cells entrances may have been blocked leading to lower CO₂ absorption. The CHS and both ZHSs also desorbed about 90% of CO₂ absorbed during a cycle.

As used herein, the singular forms “a,” “an,” and “the” include plural referents unless the context clearly dictates otherwise. Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

It is also noted that recitations herein refer to a component of the present invention being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

It will be apparent to those skilled in the art that various modifications and variations can be made to the present invention without departing from the spirit and scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

1. A carbon dioxide capture article comprising:
a honeycomb substrate formed from the group consisting of a cordierite, a hydrophilic zeolite, a hydrophobic MOF, or combinations thereof,
wherein the honeycomb substrate includes a plurality of partition walls extending in an axial direction from an inlet end to an outlet end,
wherein the plurality of partition walls include a plurality of pores; an amine alcohol contained within at least one of the plurality of pores of the partition walls; and
wherein the honeycomb substrate having the amine alcohol absorbs carbon dioxide from a target gas.

2. The article of claim 1 herein the hydrophilic zeolite has a silicon to aluminum ratio (n_{Si}:n_{Al}) of 1≤n_{Si}:n_{Al}≤50.

3. The article of claim 1 wherein the hydrophilic zeolite is selected from the group consisting of 13X, ZSM-5, EMT; NaY, an aluminophosphate, chabazite; halloysite, and MCM-41.

4. The article of claim 1 wherein the honeycomb substrate has a porosity from about 10% to about 90%.

5. The article of claim 1 wherein the plurality of pores within the partition walls of the honeycomb substrate have a diameter between about 0.1 micron and about 20 microns.

6. The article of claim 1 wherein the plurality of pores within the partition walls of the honeycomb substrate have a median pore diameter D50 from about 0.2 microns to about 5 microns.

7. The article of claim 1 wherein the amine alcohol has a boiling point≥150° C.

8. The article of claim 1 wherein the amine alcohol has a viscosity greater than the viscosity of water at a temperature between 20° C. and 400° C.

9. The article of claim 1 wherein the amine alcohol is selected from the group consisting of monoethanolamine, diethanolamine, triethanolamine, 1-(2-Hydroxyethyl)piperazine, N-(3-Aminopropyl)diethanolamine, or combinations thereof.

10. The article of claim 1 wherein the amount of amine alcohol contained within the plurality of pores of the honeycomb substrate is from about 0.1 to about 2 grams per cubic centimeter.

11. The article of claim 1 wherein the amine alcohol is contained within at least one of the plurality of pores of the honeycomb substrate by a hydrophilic interaction.

12. The article of claim 1 wherein the amine alcohol contained within the plurality of pores of the honeycomb substrate is a liquid.

13. The article of claim 1 wherein the plurality of partition walls of the honeycomb substrate have a median thickness TD of 0.05 millimeters≤TD≤0.26 millimeters.

14. The article of claim 1 wherein the plurality of partition walls define from 31 to 140 open cells per square centimeter of honeycomb substrate, the open cells substantially parallel with the axial direction.

15. A carbon dioxide capture article comprising:
a honeycomb substrate formed from the group consisting of a cordierite, a hydrophilic zeolite, a hydrophobic MOF, or combinations thereof,
wherein the honeycomb substrate includes a plurality of partition walls extending in an axial direction from an inlet end to an outlet end,
wherein the plurality partition walls include a plurality of pores, a volume of an amine alcohol selected from the group consisting of monoethanolamine, diethanolamine, triethanol amine, 1-(2-Hydroxyethyl)piperazine, N-(3-Aminopropyl)diethanolamine, or combinations thereof,
wherein the volume of the amine alcohol s contained within at least one of the plurality of pores of the plurality of partition walls; and
wherein the honeycomb substrate having the amine alcohol selectively absorbs carbon dioxide from a target gas.

16. A method of using the carbon dioxide capture article of claim 15 in a process for capturing carbon dioxide comprising:
causing relative movement between the honeycomb substrate including the amine alcohol and the target gas to absorb carbon dioxide from the target gas within the honeycomb substrate.

17. A method of manufacturing the article of claim 1, the method comprising:
contacting the honeycomb substrate and a volume V1 of the amine alcohol, wherein a portion of the volume V1 of the amine alcohol is contained within the at least one of the plurality of pores of the contacted honeycomb substrate.

18. The method of claim 17 wherein contacting the honeycomb substrate and the volume V1 of the amine alcohol solution includes applying a vacuum to the honeycomb substrate to draw the portion of the volume V1 of the amine alcohol into the at least one of the plurality of pores of the contacted honeycomb substrate to imbibe the portion of the volume V1 in the pores.

19. The method of claim 17 further comprising separating the contacted honeycomb substrate and the volume V1 of the amine alcohol.

20. The method of claim 19 further comprising washing the contacted honeycomb substrate with a volume of polar solvent.
